(19) United States
(12) Patent Application Publication
(10) Pub. No.: US 2012/0054349 A1
(43) Pub. Date: Mar. 1, 2012

(54) SESSION ADMISSION CONTROL ON SIP TRUNK LEGS

(75) Inventors: Subramanian Chandrasekaran, Redmond, WA (US); Kenneth Araujo, Redmond, WA (US)

(73) Assignee: Microsoft Corporation, Redmond, WA (US)

(21) Appl. No.: 12/869,120

(22) Filed: Aug. 26, 2010

(51) Int. Cl. G06F 15/16

(52) U.S. Cl. 709/227

(57) ABSTRACT

The present invention extends to methods, systems, and computer program products for session admission control on SIP trunk legs. Embodiments of the invention permit an administrator to set a bandwidth limit (e.g., in accordance with a defined SLA) on network traffic between a mediation server and a service provider's media termination point. The bandwidth limit enables an enterprise to limit bandwidth utilization on a SIP trunk.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

In some computing environments, Session Initiation Protocol (“SIP”) trunking is used to blend connections for various different types of media (e.g., data and voice) together into a single line. For example, a SIP trunking device can be used to convert between a legacy phone system and an Internet connection.

SIP trunking solutions typically include three components: an Internet Protocol (“IP”) Private Branch Exchange (“PBX”), an Internet Telephony Service Provider (“ITSP”), and a border element. The IP PBX communicates with endpoints on an IP network. The IP PBX also switches calls betweenVoice over Internet Protocol (“VoIP”) users on local lines while allowing users to share a number of external phone lines. The IP PBX can also switch calls between a VoIP user and a traditional telephone user.

The ITSP ensures connectivity to the Public Switched Telephone Network (“PSTN”) from an IP network for mobile and fixed communication devices. It also transports IP communication across a private or public (e.g., Internet) IP network. The border element (e.g., a SIP capable firewall, a SIP enable device connected to a firewall, or a switch) is used to transfer calls into and out of a Public Switched Telephone Network (“PSTN”). An ITSP typically provides SIP trunking as an element of an IP phone system package.

SIP trunking has a number of advantages including: reducing the need to buy equipment (e.g., Time Division Multiplexing (“TDM”) gateway or desktop equipment), reducing monthly expenses, permitting outsourcing of PTSN connections, etc. As such, entities are often able to realize instant cost savings from a modest investment in SIP-based technology.

To utilize SIP trunking, a user and ITSP come to agreement on SIP trunking resources are to be allocated for use by the user and at what price. For example, a user can sign up for a set bandwidth utilization through a SIP trunk. The agreement is often represented as a Service Level Agreement (“SLA”) between the used and ITSP. An ITSP typically allows a user to exceed the terms of an SLA but at a much more expensive cost to the user. Unfortunately, users typically have no way to regulate and/or limit bandwidth utilization on a SIP trunk. Further, due at least in part to the generated revenue when a user exceeds their set bandwidth utilization, a ITSP has little or no motivation to provide mechanisms for their users to regulate and/or limit bandwidth utilization.

### BRIEF SUMMARY

The present invention extends to methods, systems, and computer program products for session admission control on Session Initiation Protocol (“SIP”) trunk legs. A mediation server and a client reside within a site location. The mediation server receives a request to initiate a session between the client and another component external to the site location. The mediation server is connected to the other component via a SIP trunk leg. The request can originate from the client or from the external component and indicates that the session is to consume a specified amount of SIP trunk bandwidth.

The mediation server accesses a value representing the amount of SIP trunk bandwidth being used by other sessions having participants within the site location. A remaining available amount of SIP trunk bandwidth is calculated based on the allocated SIP trunk bandwidth defined in the site policy and the value representing the amount of SIP trunk bandwidth being used. The mediation server determines if admission of the session onto the SIP trunk leg is appropriate based on the specified amount of SIP trunk bandwidth that is to be consumed by the session in view of the remaining available amount of SIP trunk bandwidth.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates session admission control on Session Initiation Protocol (“SIP”) trunk legs.

FIG. 2 illustrates a flow chart of an example method for session admission control on Session Initiation Protocol (“SIP”) trunk legs.

### DETAILED DESCRIPTION

The present invention extends to methods, systems, and computer program products for session admission control on Session Initiation Protocol (“SIP”) trunk legs. A mediation server and a client reside within a site location. The mediation server receives a request to initiate a session between the client and another component external to the site location. The mediation server is connected to the other component via a SIP trunk leg. The request can originate from the client or from the external component and indicates that the session is to consume a specified amount of SIP trunk bandwidth.

The mediation server accesses a value representing the amount of SIP trunk bandwidth being used by other sessions having participants within the site location. A remaining available amount of SIP trunk bandwidth is calculated based on the allocated SIP trunk bandwidth defined in the site policy and the value representing the amount of SIP trunk bandwidth being used. The mediation server determines if admission of the session onto the SIP trunk leg is appropriate based on the specified amount of SIP trunk bandwidth that is to be consumed by the session in view of the remaining available amount of SIP trunk bandwidth.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote computer storage media (devices).

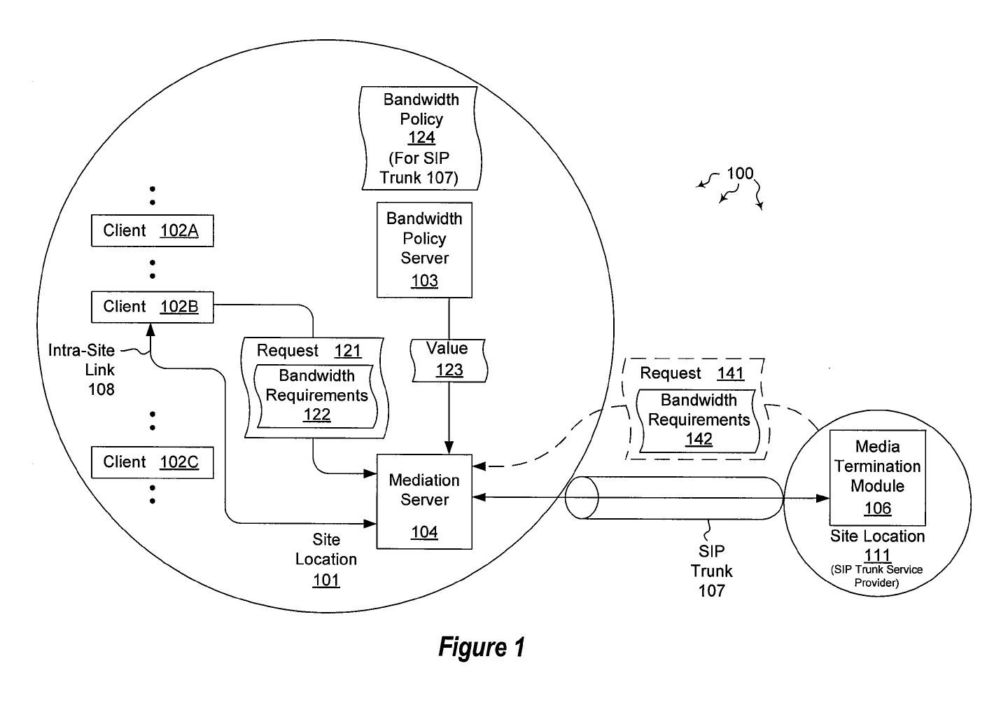

FIG. 1 illustrates an example computer architecture 100 that facilitates session admission control on Session Initiation Protocol (“SIP”) trunk legs. Referring to FIG. 1, computer architecture 100 includes site location 101, SIP trunk 107, and site location 111 (e.g., a SIP trunks service provider). Site location 101 can be connected to site 111 via SIP trunk 107. SIP trunk 107 can be part of a network, such as, for example, a Local Area Network (“LAN”), a Wide Area Network (“WAN”), and even the Internet. SIP trunk 107 can be used to transfer video and/or audio data (e.g., included in telephonic or video conference communication) between site location 101 and site location 111. Accordingly, any components within site location 101 and site location 111 can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over SIP trunk 107.

Site location 101 further includes clients 102A-102C, bandwidth policy server 103, and mediation server 104. The components within site location 101 can be included in (or be part of) other networks. Thus, within site location 101, components can create message related data and exchange message related data using various protocols, without communicating over SIP trunk 107. Generally, mediation server 104 controls the exchange of data (e.g., establishment of sessions) between site location 101 and SIP trunk 107 (an inter-site link). More specifically, mediation server 104 determines if sessions can be admitted onto SIP trunk 107 in compliance with bandwidth policy 124.

An administrator can set a bandwidth policy (e.g., bandwidth policy 124) for site location 101. Bandwidth policy server 103 can maintain the bandwidth policy electronically. Bandwidth policy server 103 can also monitor bandwidth usage of SIP trunk 107 on a per session basis. From the monitoring, bandwidth policy server 103 can calculate a value representing the total amount of SIP trunk bandwidth in use (e.g., the sum of SIP bandwidth usage by all sessions originating within site location 101).

From the total about of SIP trunk bandwidth in use and in view of bandwidth requirements in a new session request, mediation server 104 can determine if admission of a new session onto SIP trunk 107 is appropriate. Admission can be appropriate when admission does not result in site location 101 exceeding an allocated SIP trunk bandwidth (e.g., defined in bandwidth policy 124). Admission is not appropriate when it results in site location 101 exceeding the allocated SIP trunk bandwidth (e.g., potentially resulting in overage charges).

Mediation server 104 can also regulate the establishment of sessions between components within site location 101 (intra-site links) so as to not overload available bandwidth within site 101. In some embodiments, mediation server 104 considers available bandwidth within site location 101 and available bandwidth of SIP trunk 107 when determining if admitting a new session onto SIP trunk 107 is appropriate.

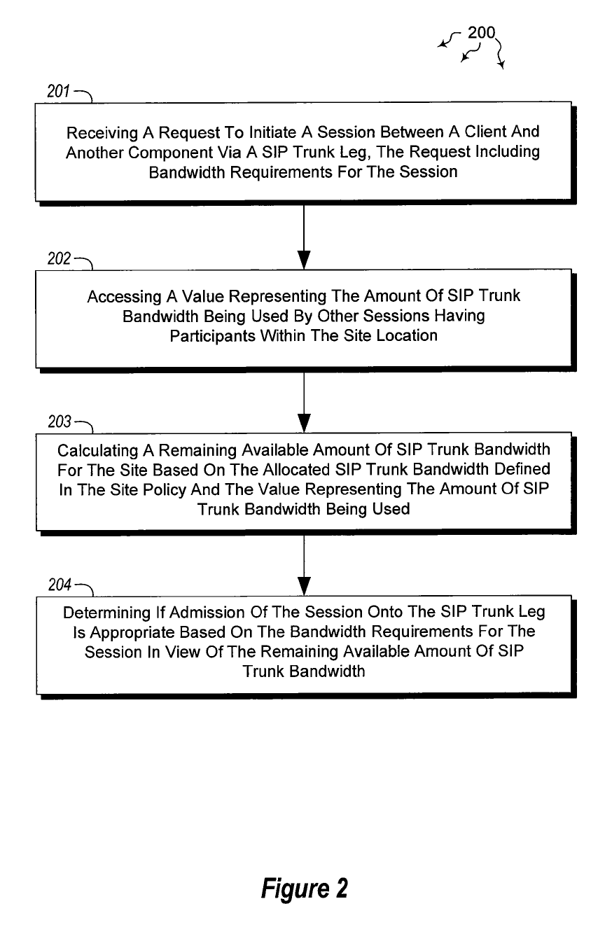

FIG. 2 illustrates a flow chart of an example method 200 for session admission control on Session Initiation Protocol (“SIP”) trunk legs. Method 200 will be described with respect to the components and data of computer architecture 100.

Method 200 includes an act of receiving a request from a client within the site location to initiate a session from the client to a destination, the mediation server connected to the destination via the SIP trunk leg, the request indicating that the session is to consume a specified amount on SIP trunk bandwidth (act 201). For example, mediation server 104 can receive request 121 from client 102B (. Request 121 can be a request to establish a session (e.g., for video and/or audio data) between client 102B and media termination module 106 (e.g., an interface to and/or a media termination point for a Public Switched Telephone Network (“PTSN”) via SIP trunk 107 (e.g., for an outbound call from client 102B). Request 121 includes bandwidth requirements 122. Bandwidth requirements 122 indicate the amount of bandwidth (on SIP trunk 107 and within site 101) the session for client 102B is to consume.

Alternately, mediation server 104 can receive request 141 from media termination module 106. Request 141 can be a request to establish a session (e.g., for audio and/or video data) between client 102B and media termination module 106 via SIP trunk 107 (e.g., for an inbound call to client 102B). Request 141 includes bandwidth requirements 142. Bandwidth requirements 142 indicate the amount of bandwidth (on SIP trunk 107 and within site 101) the session for client 102B is to consume.

Method 200 includes an act of accessing a value representing the amount of SIP trunk bandwidth being used by other sessions having participants within the site location (act 202). From time to time, existing sessions can indicate to bandwidth policy server 103 the amount of bandwidth on SIP trunk being utilized. From these indications, bandwidth policy server 103 can track the aggregate consumed amount of bandwidth for all sessions originated in site location 101. Bandwidth policy server 103 can formulate value 123 to represent the amount of bandwidth on SIP trunk 107 being consumed by other sessions originating within site location 101. Mediation server 104 can access value 123 from bandwidth policy serer 103.

Method 200 includes an act of calculating a remaining available amount of SIP trunk bandwidth based on the allocated SIP trunk bandwidth defined in the site policy and the value representing the amount of SIP trunk bandwidth being used (act 203). Mediation server 104 can access bandwidth policy 124. Bandwidth policy 124 defines the amount of bandwidth from SIP trunk 107 allocated to site location 101 The allocated bandwidth can be defined in a Service Level Agreement (“SLA”) between the owner of site location 107 and a SIP trunk service provider managing media termination module 106. From value 123 and bandwidth policy 124, mediation server 104 can calculate the available remaining amount of bandwidth that can be allocated for sessions from site location 101.

Method 200 includes an act of determining if admission of the session onto the SIP trunk leg is appropriate based on the specified amount of SIP trunk bandwidth that is to be consumed by the session in view of the remaining available amount of SIP trunk bandwidth for the site location (act 204). For example, mediation server 104 can determine if it is appropriate to admit the session requested by client 102B (or requested by mediation termination module 106) on SIP trunk 107. The determination can be made based on bandwidth requirements 122 (or bandwidth requirements 142) in view of the remaining available bandwidth on SIP trunk 107. The determination can also be made based on bandwidth requirements 122 (or bandwidth requirements 144) in view of the bandwidth within site location 101. For example, mediation server 104 can determine the available bandwidth on intra-site link 108 between mediation server 104 and client 102B.

When available bandwidth within site location 101 and on SIP trunk 107 is sufficient, mediation server 104 can admit the requested session (either from or to client 102B) onto SIP trunk 107. When the session is admitted, the session can connect client 102B to media termination module 106 (the interface to the PTSN). When available bandwidth within site location 101 is not sufficient, mediation server can prevent establishment of the request session (from or to client 102B) onto SIP trunk 107. Preventing the session due to bandwidth constraints within site location 101 can reduce network congestion within site location 101. When available bandwidth on SIP trunk 107 is not sufficient, mediation server can prevent establishment of the request session (from or to client 102B) onto SIP trunk 107. Preventing the session in accordance with bandwidth policy 124 can prevent overage charges to the SIP trunk service provider.

Accordingly, embodiments of the invention permit an administrator to set a bandwidth limit (e.g., in accordance with a defined SLA) on network traffic between a mediation server and a service providers media termination point. The bandwidth limit enables an enterprise to limit bandwidth utilization on a SIP trunk.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a mediation server including one or more processors and system memory, the mediation server residing within a site location along with one or more clients, the mediation server including a mediation server configured to connect to a Session Initiation Protocol (SIP) trunk leg, a site policy defining an amount of allocated bandwidth from the SIP trunk leg that is allocated to the site location, a method for determining if a client session can be admitted onto the SIP trunk leg, the method comprising:
an act of receiving a request to initiate a session between a client, include in the one or more clients, an another component, the mediation server connected to the other component via the SIP trunk leg, the request indicating that the session is to consume a specified amount of SIP trunk bandwidth;
an act of accessing a value representing the amount of SIP trunk bandwidth being used by other sessions having participants within the site location;
an act of calculating a remaining available amount of SIP trunk bandwidth based on the allocated SIP trunk bandwidth defined in the site policy and the value representing the amount of SIP trunk bandwidth being used; and
an act of determining if admission of the session onto the SIP trunk leg is appropriate based on the specified amount of SIP trunk bandwidth that is to be consumed by the session in view of the remaining available amount of SIP trunk bandwidth for the site location.

2. The method as recited in claim 1, wherein the act of receiving a request to initiate a session comprises an act of receiving a request to establish a session for one or more of: video data and audio data.

3. The method as recited in claim 1, wherein the act of receiving a request to initiate session comprises receiving a request to initiate a session from the client.

4. The method as recited in claim 1, wherein the act of receiving a request to initiate session comprises receiving a request to initiate a session from the other component, wherein the other component is a media termination point for a Public Switched Telephone Network (PTSN).

5. The method as recited in claim 1, wherein the act of accessing a value representing the amount of SIP trunk bandwidth being used by other sessions having participants within the site location comprise an act of access the value from a bandwidth policy server that monitors other sessions within the site location.

6. The method as recited in claim 1, further comprising an act of the mediation server calculating the amount of available bandwidth within the site location.

7. The method as recited in claim 6, wherein the act of determining if admission of the session onto the SIP trunk leg is appropriate comprises an act of determining if admission of the session onto the SIP trunk leg is appropriate based on the amount of available bandwidth within the site location.

8. The method as recited in claim 7, wherein the act of determining if admission of the session onto the SIP trunk leg is appropriate comprises an act of determining that sufficient bandwidth is available both within the site location on the SIP trunk leg to satisfy the bandwidth requirements of the session; and further comprising:
an act of the mediation server admitting the session onto the SIP trunk.

9. The method as recited in claim 7, wherein the act of determining if admission of the session onto the SIP trunk leg is appropriate comprises an act of determining that at least one of the site location and the SIP trunk leg lack sufficient available bandwidth to satisfy the bandwidth requirements of the session.

10. The method as recited in claim 1, wherein the act of determining if admission of the session onto the SIP trunk leg is appropriate comprises an act of determining that admitting the session onto the SIP trunk leg would result in the site location consuming more SIP trunk bandwidth than defined in a Service Level Agreement (SLA) between the site location and a SIP trunk service provider.

11. The method as recited in claim 1, wherein at least part of the SIP trunk leg traverses the Internet.

12. A computer program product for use at a mediation server, the mediation server residing within a site location along with one or more clients, the mediation server including a server component configured to connect to a Session Initiation Protocol (SIP) trunk leg, a site policy defining an amount of allocated bandwidth from the SIP trunk leg that is allocated to the site location, the computer program product for implementing a method for determining if a client session can be admitted onto the SIP trunk leg, the computer program product comprising one or more computer storage devices having stored thereon computer-executable instructions that, when executed at a processor, cause the mediation server to perform the method, including the following:
receive a request from a client within the site location to initiate a session from the client to a destination, the mediation server connected to the destination via the SIP trunk leg, the request indicating that the session is to consume a specified amount of SIP trunk bandwidth;
access a value representing the amount of SIP trunk bandwidth being used by other sessions originating within the site location;
calculate a remaining available amount of SIP trunk bandwidth based on the allocated SIP trunk bandwidth defined in the site policy and the value representing the amount of SIP trunk bandwidth being used; and
determine if admission of the session onto the SIP trunk leg is appropriate based on the specified amount of SIP trunk bandwidth that is to be consumed by the session in view of the remaining available amount of SIP trunk bandwidth for the site location.

13. The computer program product as recited in claim 12, wherein computer-executable instructions that, when executed, cause the mediation server to receive a request from a client within the site location to initiate a session comprises computer-executable instructions that, when executed, cause the mediation server to receive a request to establish a session for one or more of: video data and audio data.

14. The computer program product as recited in claim 10, further comprising computer-executable instructions that, when executed, cause the mediation server to calculate the amount of available bandwidth within the site location.

15. The computer program product as recited in claim 13, computer-executable instructions that, when executed, cause the mediation server to determine if admission of the session onto the SIP trunk leg is appropriate comprise computer-executable instructions that, when executed, cause the mediation server to determine if admission of the session onto the SIP trunk leg is appropriate based on the amount of available bandwidth within the site location.

16. The computer program product as recited in claim 15, wherein computer-executable instructions that, when executed, cause the mediation server to determine if admission of the session onto the SIP trunk leg is appropriate comprise computer-executable instructions that, when executed, cause the mediation server to determine that sufficient bandwidth is available both within the site location on the SIP trunk leg to satisfy the bandwidth requirements of the session; and
further comprising computer-executable instructions that, when executed, cause the mediation server to admit the session onto the SIP trunk.

17. The computer program product as recited in claim 15, wherein computer-executable instructions that, when executed, cause the mediation server to determine if admission of the session onto the SIP trunk leg is appropriate comprise computer-executable instructions that, when executed, cause the mediation server to determine that at least one of: the site location and the SIP trunk leg lack sufficient available bandwidth to satisfy the bandwidth requirements of the session.

18. The computer program product as recited in claim 10, wherein computer-executable instructions that, when executed, cause the mediation server to determine if admission of the session onto the SIP trunk leg is appropriate comprise computer-executable instructions that, when executed, cause the mediation server to determine that admitting the session onto the SIP trunk leg would result in the site location consuming more SIP trunk bandwidth than defined in a Service Level Agreement (SLA) between the site location and a SIP trunk service provider.

19. A network system, the network system for regulating Session Initiation Protocol (“SIP”) bandwidth consumption for a site location, the network system comprising:
a mediation server within the site location;
a bandwidth policy server within the site location;
a plurality of clients within the site location;
wherein the mediation server comprises:
system memory;
one or more processors; and
one or more computer storage devices having stored thereon computer-executable instructions representing that the mediation server is configured to:
receive a request to establish a connection between a client, selected from the plurality of clients, and a media termination point for a Public Switched Telephone Network (PTSN), the mediation server connected to the termination point via the SIP trunk leg, the request indicating that the session is to consume a specified amount of SIP trunk bandwidth;
access a value representing the amount of SIP trunk bandwidth being used by other sessions having participants within the site location;
calculate a remaining available amount of SIP trunk bandwidth based on the allocated SIP trunk bandwidth defined in the site policy and the value representing the amount of SIP trunk bandwidth being used; and
determine if admission of the session onto the SIP trunk leg is appropriate based on the specified amount of SIP trunk bandwidth that is to be consumed by the session in view of the remaining available amount of SIP trunk bandwidth for the site location;
wherein the bandwidth policy server comprises:
system memory;
one or more processors; and
one or more computer storage devices having stored thereon computer-executable instructions representing that the bandwidth policy server is configured to:
monitoring the SIP trunk bandwidth being consumed by the plurality of clients; and
calculated the value representing the amount of SIP trunk bandwidth being used by other sessions originating within the site location based on the monitoring.

20. The computer system as recited in claim 19, wherein the mediation server being configured to receive a request to establish a session between a client and a media termination endpoint comprises the mediation server being configured to receive a request to establish a session from one of: the client and the media termination endpoint; and
wherein the mediation server is further configured to determine if admission of the session onto the SIP trunk leg is appropriate based on the available bandwidth within the site location.
